(19) United States
(12) Patent Application Publication
(10) Pub. No.: US 2024/0394859 A1
(43) Pub. Date: Nov. 28, 2024

(54) EVALUATION APPARATUS, EVALUATION METHOD, AND STORAGE MEDIUM

(71) Applicant: NEC Corporation, Tokyo (JP)

(72) Inventor: Katsushi MATSUDA, Toyota (JP)

(73) Assignee: NEC Corporation, Tokyo (JP)

(21) Appl. No.: 18/666,965

(22) Filed: May 17, 2024

(30) Foreign Application Priority Data
May 22, 2023 (JP) 2023-084071

(51) Int. Cl. G06T 7/00; G06T 11/00; G06V 10/44

(52) U.S. Cl. CPC G06T 7/0002; G06T 11/00; G06V 10/44; G06T 2207/30168

(57) ABSTRACT

In order to attain an example object of narrowing down a cause of a case where performance of a language processing model is not satisfactory, an evaluation apparatus includes: an acquisition section for acquiring embeddings of natural language sentences that are respectively included in a plurality of training data pieces with use of an embedding layer included in a language processing model; a generation section for generating image data by converting elements of a matrix which includes the embeddings as rows or columns into pixel values; a detection section for detecting a feature of the image data; and an evaluation section for evaluating quality of the embedding layer based on the feature of the image data. Thus, it is possible to optimize performance of a language processing model which has been subjected to machine learning.

This Nonprovisional application claims priority under 35 U.S.C. § 119 on Patent Application No. 2023-084071 filed in Japan on May 22, 2023, the entire contents of which are hereby incorporated by reference.

### TECHNICAL FIELD

The present invention relates to a technique to evaluate performance of a language processing model.

### BACKGROUND ART

In recent years, it is known that a language processing model which carries out an intended language processing task is generated by fine-tuning a general-purpose natural language processing model as a pre-trained model. Performance of such a language processing model is affected by, for example, training data used to generate the language processing model, a pre-trained model, a training algorithm, hyperparameters employed in the language processing model, and the like. For the purpose of improving performance of such a language processing model, it is known to use, for example, a technique (such as grid search) for adjusting hyperparameters. For example, Patent Literature 1 discloses a technique for improving quality of training data.

### CITATION LIST

### Patent Literature

### [Patent Literature 1]

Japanese Patent Application Publication Tokukai No. 2023-19341

### SUMMARY OF INVENTION

### Technical Problem

However, in a case where the performance of the language processing model is not satisfactory, it is difficult to narrow down which one of the training data, the pre-trained model, the training algorithm, the hyperparameters, and the like as described above mainly causes the unsatisfactory performance. The technique disclosed in Patent Literature 1 is effective in a case where it is known that the main cause of the unsatisfactory performance is in quality of the training data. In the other cases, however, there is a possibility that the performance of the language processing model cannot be improved even if the quality of the training data is improved. Therefore, it is important to narrow down the cause of a case where the performance of the language processing model is not satisfactory.

An example aspect of the present invention is accomplished in view of the above problem, and an example object thereof is to provide a technique for narrowing down a cause of a case where performance of a language processing model is not satisfactory.

### Solution to Problem

An evaluation apparatus in accordance with an example aspect of the present invention includes at least one processor, the at least one processor carrying out: an acquisition process of acquiring embeddings for natural language sentences that are respectively included in a plurality of training data pieces, the embeddings having been generated with use of an embedding layer included in a language processing model; a generation process of generating image data by converting elements of a matrix which includes the embeddings as rows or columns into pixel values; a detection process of detecting a feature of the image data; and an evaluation process of evaluating quality of the embedding layer based on the feature of the image data.

An evaluation method in accordance with an example aspect of the present invention is carried out by at least one processor, the evaluation method including: acquiring, by the at least one processor, embeddings for natural language sentences that are respectively included in a plurality of training data pieces, the embeddings having been generated with use of an embedding layer included in a language processing model; generating, by the at least one processor, image data by converting elements of a matrix which includes the embeddings as rows or columns into pixel values; detecting, by the at least one processor, a feature of the image data; and evaluating, by the at least one processor, quality of the embedding layer based on the feature of the image data.

A non-transitory storage medium in accordance with an example aspect of the present invention stores a program for causing a computer to carry out: an acquisition process of acquiring embeddings for natural language sentences that are respectively included in a plurality of training data pieces, the embeddings having been generated with use of an embedding layer included in a language processing model; a generation process of generating image data by converting elements of a matrix which includes the embeddings as rows or columns into pixel values; a detection process of detecting a feature of the image data; and an evaluation process of evaluating quality of the embedding layer based on the feature of the image data.

### Advantageous Effects of Invention

According to an example aspect of the present invention, it is possible to narrow down a cause of a case where performance of a language processing model is not satisfactory.

### BRIEF DESCRIPTION OF DRAWINGS

FIG. 1 is a block diagram illustrating a configuration of an evaluation apparatus in accordance with a first example embodiment of the present invention.

FIG. 2 is a flowchart illustrating a flow of an evaluation method in accordance with the first example embodiment of the present invention.

FIG. 3 is a block diagram illustrating a configuration of an evaluation system including an evaluation apparatus in accordance with a second example embodiment of the present invention.

FIG. 4 is a flowchart for describing a flow of an evaluation method in accordance with the second example embodiment of the present invention.

FIG. 5 is a schematic diagram illustrating an example of embeddings in the second example embodiment of the present invention.

FIG. 6 is a flowchart illustrating a detailed flow of a generation process in the second example embodiment of the present invention.

FIG. 7 is a schematic diagram illustrating an example of a matrix in the second example embodiment of the present invention.

FIG. 8 is a schematic diagram illustrating a specific example of assignment of pixel values in the second example embodiment of the present invention.

FIG. 9 is a schematic diagram illustrating an example of image data in the second example embodiment of the present invention.

FIG. 10 is a flowchart illustrating a detailed flow of a detection process in the second example embodiment of the present invention.

FIG. 11 is a schematic diagram illustrating an example of a first boundary in the second example embodiment of the present invention.

FIG. 12 is a flowchart illustrating a detailed flow of an evaluation process in the second example embodiment of the present invention.

FIG. 13 is a diagram illustrating image data in a specific example in the second example embodiment of the present invention.

FIG. 14 is a diagram illustrating first boundaries and second boundaries in a specific example in the second example embodiment of the present invention.

FIG. 15 is a diagram illustrating an example of a hardware configuration of the evaluation apparatus in accordance with each of the example embodiments.

### EXAMPLE EMBODIMENTS

The inventors of the present invention have focused attention on a fact that a cause of a case where performance of a language processing model is not satisfactory can be narrowed down according to quality of an embedding layer included in the language processing model, and have invented an evaluation apparatus for evaluating quality of an embedding layer. If performance of a language processing model is poor despite good quality of an embedding layer, it is highly likely that a cause thereof is in a language processing task layer (e.g., hyperparameters). Meanwhile, in a case where quality of an embedding layer is not satisfactory, it is highly likely that there is a problem in training data, a pre-trained model, or a training algorithm related to a generation process of the embedding layer. Thus, by using the evaluation apparatus in accordance with an example aspect of the present invention, it is possible to narrow down, according to a result of evaluating quality of an embedding layer, a cause of a case where performance of a language processing model is not satisfactory.

### First Example Embodiment

The following description will discuss a first example embodiment of the present invention in detail, with reference to the drawings. The present example embodiment is a basic form of example embodiments described later.

### (Configuration of Evaluation Apparatus 1)

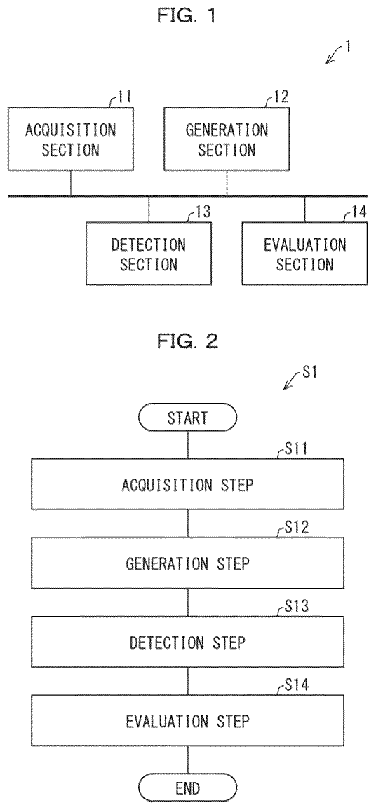

The following description will discuss a configuration of an evaluation apparatus 1 in accordance with the present example embodiment, with reference to FIG. 1. FIG. 1 is a block diagram illustrating the configuration of the evaluation apparatus 1. As illustrated in FIG. 1, the evaluation apparatus 1 includes an acquisition section 11, a generation section 12, a detection section 13, and an evaluation section 14.

The acquisition section 11 acquires embeddings for natural language sentences that are respectively included in a plurality of training data pieces, the embeddings having been generated with use of an embedding layer included in a language processing model. The generation section 12 generates image data by converting elements of a matrix which includes a plurality of embeddings as rows or columns into pixel values. The detection section 13 detects a feature of the image data. The evaluation section 14 evaluates quality of the embedding layer based on the feature of the image data.

### (Example of Implementation by Program)

In a case where the evaluation apparatus 1 is configured by a computer including at least one processor and a memory, the following program in accordance with the present example embodiment is stored in the memory. The program causes the computer to function as: the acquisition section 11 for acquiring embeddings for natural language sentences that are respectively included in a plurality of training data pieces, the embeddings having been generated with use of an embedding layer included in a language processing model; the generation section 12 for generating image data by converting elements of a matrix which includes the embeddings as rows or columns into pixel values; the detection section 13 for detecting a feature of the image data; and the evaluation section 14 for evaluating quality of the embedding layer based on the feature of the image data.

### (Flow of Evaluation Method S1)

The evaluation apparatus 1 configured as described above carries out an evaluation method S1 in accordance with the present example embodiment. The following description will discuss a flow of the evaluation method S1, with reference to FIG. 2. FIG. 2 is a flowchart illustrating the flow of the evaluation method S1. As illustrated in FIG. 2, the evaluation method S1 includes steps S11 through S14.

In step S11, the at least one processor acquires embeddings for natural language sentences that are respectively included in a plurality of training data pieces, the embeddings having been generated with use of an embedding layer included in a language processing model. In step S12, the at least one processor generates image data by converting elements of a matrix which includes a plurality of embeddings as rows or columns into pixel values. In step S13, the at least one processor detects a feature of the image data. In step S14, the at least one processor evaluates quality of the embedding layer based on the feature of the image data.

As described above, the present example embodiment employs the configuration of: acquiring embeddings for natural language sentences that are respectively included in a plurality of training data pieces, the embeddings having been generated with use of an embedding layer included in a language processing model; generating image data by converting elements of a matrix which includes the embeddings as rows or columns into pixel values; detecting a feature of the image data; and evaluating quality of the embedding layer based on the feature of the image data. Therefore, according to the present example embodiment, it is possible to bring about an example advantage of narrowing down, according to a result of evaluating an embedding layer, a cause of a case where quality of a language processing model is not satisfactory.

### Second Example Embodiment

The following description will discuss an evaluation apparatus 1A in accordance with a second example embodiment of the present invention in detail, with reference to the drawings. The same reference numerals are given to constituent elements which have functions identical with those described in the first example embodiment, and descriptions as to such constituent elements are omitted as appropriate.

### (Configuration of Evaluation Apparatus 1A)

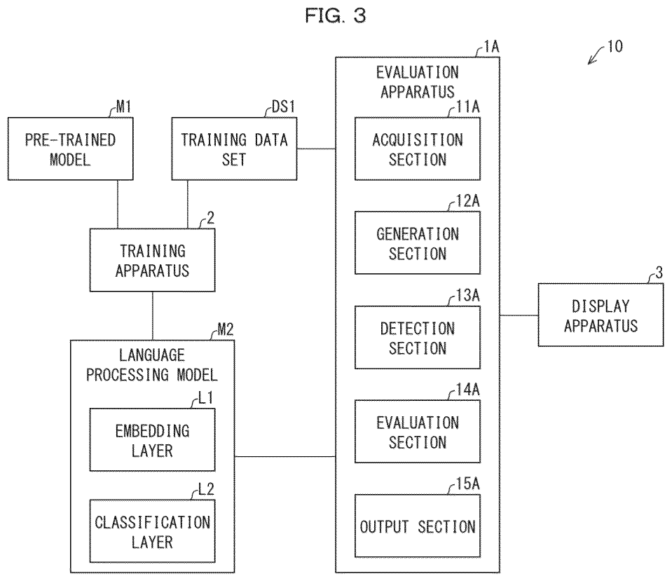

FIG. 3 is a block diagram illustrating a configuration of an evaluation system 10 including the evaluation apparatus 1A. As illustrated in FIG. 3, the evaluation system 10 includes the evaluation apparatus 1A, a training apparatus 2, and a display apparatus 3. The evaluation apparatus 1A and the training apparatus 2 may be communicatively connected to each other. Note, however, that the evaluation apparatus 1A and the training apparatus 2 do not need to be able to communicate with each other, and do not need to be connected to each other. The display apparatus 3 is connected to the evaluation apparatus 1A and displays information under control of the evaluation apparatus 1A.

The evaluation apparatus 1A is an apparatus for evaluating quality of an embedding layer included in a language processing model M2. In the present example embodiment, a deep learning model which carries out a classification task of natural language sentences is applied as the language processing model M2. The language processing model M2 has been trained, upon receipt of input of a natural language sentence, to output a classification of the natural language sentence.

The training apparatus 2 is an apparatus which generates a language processing model M2 by fine-tuning a pre-trained model M1 with use of a training data set DS1. The training data set DS1 and the language processing model M2 are stored in a storage apparatus (not illustrated) which is accessible from the evaluation apparatus 1A. In the present example embodiment, an example will be described in which the evaluation apparatus 1A refers to the training data set DS1 which has been used for generation of the language processing model M2. Note, however, that part or all of the training data set DS1 that is referred to by the evaluation apparatus 1A does not necessarily need to be a training data set used for generation of the language processing model M2, and may be a training data set for evaluation.

The pre-trained model M1 outputs, upon receipt of input of a natural language sentence, an embedding of the natural language sentence. An embedding expresses a natural language sentence as a vector in a higher dimensional feature quantity space. Elements of an embedding are numerical values, that is, an embedding is a numerical representation of a natural language sentence. Examples of the pre-trained model M1 include bidirectional encoder representations from transformers (BERT), generative pre-trained transformer (GPT), text-to-text transfer transformer (T5), and the like. For example, an embedding outputted by bert-base-japanese-whole-word-masking (Japanese BERT) is a 768-dimensional vector. An embedding outputted by Japanese-gpt2-medium (Japanese GPT2) is a 1024-dimensional vector. An embedding outputted by t5-base-japanese (Japanese T5) is a 768-dimensional vector. Note, however, that the pre-trained model M1 is not limited to the above-described specific examples.

The training data set DS1 includes a plurality of training data pieces. A training data piece includes information (hereinafter, also referred to as a pair) in which a natural language sentence is associated with a label indicating a classification of the natural language sentence. For example, it is assumed that a label “TRUE” indicates a classification in which a natural language sentence associated with the label is correct information, and a label “FALSE” indicates a classification in which an associated natural language sentence is incorrect information. In this case, examples of the training data piece include a pair of a label “TRUE” and a natural language sentence “The capital of Japan is Tokyo”, a pair of a label “FALSE” and a natural language sentence “Osaka is the most populated prefecture in Japan”, and the like. Note that types and the number of labels that can be included in training data pieces are not limited to the example described above.

The language processing model M2 is a model that is generated by fine-tuning the pre-trained model M1 by the training apparatus 2 using the training data set DS1. The language processing model M2 includes an embedding layer L1 and a classification layer L2. The embedding layer L1 is a layer that, upon receipt of input of a natural language sentence, outputs an embedding of the natural language sentence. For input of the same natural language sentence, an embedding output from the embedding layer L1 and an embedding output from the pre-trained model M1 may not necessarily be the same, and may be different from each other. This is because the embedding layer L1 is fine-tuned based on the pre-trained model M1. The classification layer L2 is a layer that, upon receipt of input of an embedding, outputs a classification of the embedding. The language processing model M2 is trained so that, when a natural language sentence of a training data piece is input to the embedding layer L1, a label associated with the natural language sentence is output from the classification layer L2.

The evaluation apparatus 1A includes an acquisition section 11A, a generation section 12A, a detection section 13A, an evaluation section 14A, and an output section 15A. The acquisition section 11A acquires, for natural language sentences included in respective training data pieces of the training data set DS1, embeddings generated by using the embedding layer L1 included in the language processing model M2.

The generation section 12A generates, from a matrix in which embeddings are arranged as rows or columns in an order based on labels, image data in which elements of the matrix are converted into pixel values. For example, the generation section 12A may generate image data from a sorted matrix in which a plurality of rows included in the matrix have been sorted based on a first representative value calculated from elements in each of the plurality of rows. Alternatively, for example, the generation section 12A may generate image data from a sorted matrix in which a plurality of columns included in the matrix have been sorted based on a second representative value calculated from elements in each of the plurality of columns. For example, the generation section 12A may convert elements of the matrix into pixel values by assigning pixel values, which represent a plurality of colors with a predetermined number of gradations, to values ranging from a minimum value to a maximum value of the elements of the matrix.

The detection section 13A detects, as a feature of the image data, a first boundary based on change in pixel value. For example, among candidates for first boundary detected based on change in pixel value, the detection section 13A may detect, as the first boundary, a candidate extending parallel to a direction of row or column corresponding to an embedding in the image data. For example, in a case where a total length of one or more parallel candidates included in a parallel line parallel to one side of the image data is equal to or more than a predetermined proportion with respect to a length of the one side, the detection section 13A may detect the parallel line as the first boundary.

The evaluation section 14A evaluates the quality of the embedding layer based on a result of comparison between the first boundary and a second boundary which indicates a border between rows or columns corresponding to embeddings associated with different labels in the image data. For example, the evaluation section 14A may evaluate the quality of the embedding layer based on a recall ratio that indicates a proportion of the number of first boundaries which have been determined to conform to second boundaries to the number of second boundaries. Alternatively, for example, the evaluation section 14A may evaluate the quality of the embedding layer based on a detection magnification that indicates a proportion of the number of first boundaries to the number of second boundaries.

The output section 15A outputs one or both of an evaluation result by the evaluation section 14A and image data generated by the generation section 12A.

In a case where the same training data set DS1 is used to obtain both a first evaluation result and a second evaluation result, and neither the first evaluation result nor the second evaluation result satisfies a determination criterion, the evaluation section 14A evaluates that quality of the training data set DS1 does not satisfy a criterion. Here, the first evaluation result is a result of evaluating quality of the embedding layer obtained by causing the acquisition section 11A, the generation section 12A, the detection section 13A, and the evaluation section 14A to function while applying the language processing model M2 as the language processing model. The second evaluation result is a result of evaluating quality of the embedding layer obtained by causing the acquisition section 11A, the generation section 12A, the detection section 13A, and the evaluation section 14A to function while applying the language processing model M2-1 as the language processing model. The language processing model M2-1 is a model different from the language processing model M2. For example, the language processing model M2-1 can be a model that is generated by fine-tuning a pre-trained model M1-1, which is different from the pre-trained model M1, using the same training data set DS1.

### (Flow of Evaluation Method S1A)

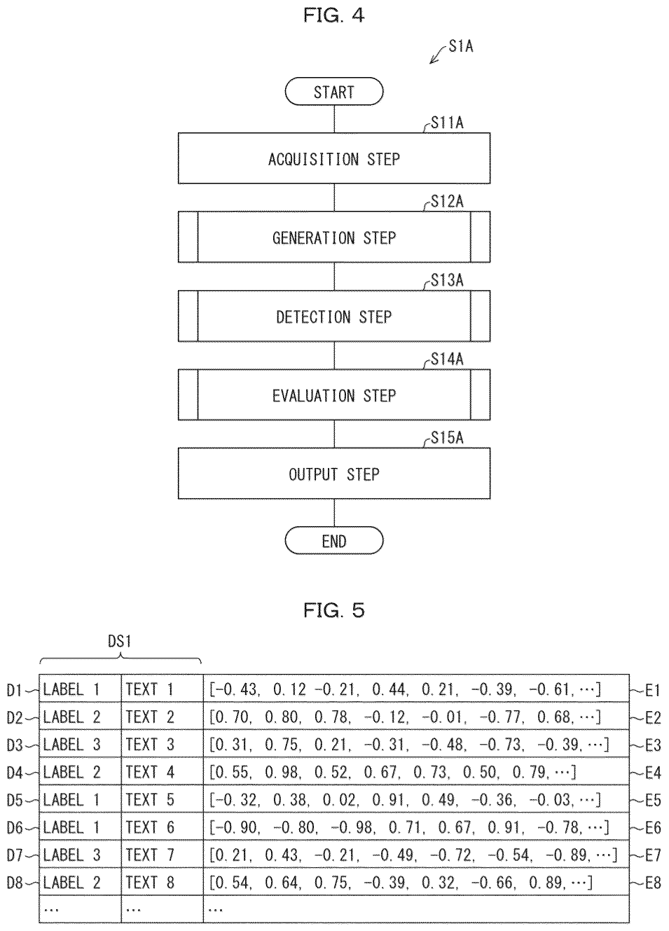

The evaluation apparatus 1A configured as described above carries out an evaluation method S1A. The following description will discuss a flow of the evaluation method S1A, with reference to FIG. 4. FIG. 4 is a flowchart for describing the flow of the evaluation method S1A. As illustrated in FIG. 4, the evaluation method S1A includes steps S11A to S15A.

In step S11A, the acquisition section 11A acquires embeddings of natural language sentences included in respective training data pieces of the training data set DS1, using the embedding layer L1 included in the language processing model M2.

FIG. 5 is a schematic diagram illustrating an example of embeddings acquired in step S11A. The training data set DS1 illustrated in FIG. 5 includes training data pieces D1 through D8. For example, the training data piece D1 includes a pair of a natural language sentence label “Label 1” and “Text 1”. The label “Label 1” indicates a classification of the natural language sentence “Text 1”. An embedding E1 is an embedding obtained by inputting the natural language sentence “Text 1” into the embedding layer L1 of the language processing model M2, and elements thereof are expressed by numerical values. The training data pieces D2 through D8 and embeddings E2 through E8 are also described in a manner similar to the training data piece D1 and the embedding E1. Hereinafter, in order to simplify the description, an “embedding acquired from a natural language sentence associated with a label” is also referred to as an “embedding associated with a label” and the like.

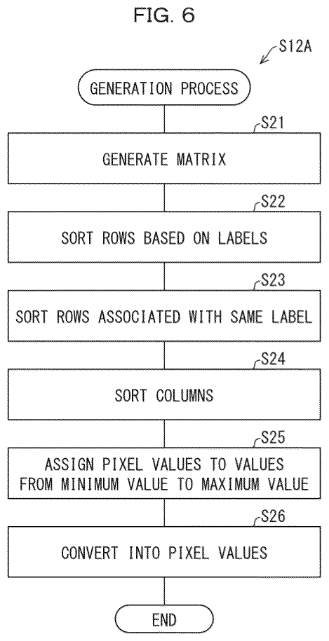

In step S12A illustrated in FIG. 4, the generation section 12A generates, from a matrix including embeddings as rows or columns, image data in which elements of the matrix are converted into pixel values. FIG. 6 is a flowchart illustrating a detailed flow of a generation process in step S12A. As illustrated in FIG. 6, the generation process (step S12A) includes steps S21 through S26.

In step S21, the generation section 12A generates a matrix which includes embeddings as rows or columns. An example will be described hereinafter in which a matrix including embeddings as rows is generated. A case where a matrix including embeddings as columns is generated can be similarly described by replacing “rows” with “columns” in the following description.

In step S22, the generation section 12A sorts the plurality of rows based on the labels. In step S23, in a case where there are a plurality of embeddings associated with the same label, the generation section 12A may sort a plurality of rows corresponding to the plurality of embeddings based on first representative values calculated from the respective rows. Thus, the plurality of rows associated with the same label are sorted based on the first representative values.

Specific examples of the first representative value include, but are not limited to, an average, a dispersion, a value obtained by dimensional compression, and the like. In addition to the first representative value, a third representative value of a type different from the first representative value may be used. For example, the generation section 12A may carry out sorting by referring to labels, first representative values, and third representative values in this order. In this case, a plurality of rows associated with the same label and the same first representative value are sorted based on the third representative values. Note that the number of types of representative values which are referred to next to labels in order to sort the plurality of rows is not limited to one or two, and may be three or more. An order in which a plurality of types of representative values are referred to for sorting of rows is not limited to the above-described example.

In step S24, the generation section 12A sorts the plurality of columns included in the matrix. For example, the generation section 12A sorts the plurality of columns based on second representative values calculated from the respective columns.

Specific examples of the second representative value is similar to those of the first representative value described in step S22. The first representative value and the second representative value may be the same type or may be different types. In addition to the second representative value, a fourth representative value of a type different from the second representative value may be used. For example, the generation section 12A may sort the plurality of columns by referring to second representative values and fourth representative values in this order. In this case, a plurality of columns associated with the same second representative value are sorted based on the fourth representative values. Note that the number of types of representative values which are referred to in order to sort the plurality of columns is not limited to one or two, and may be three or more. An order in which a plurality of types of representative values are referred to for sorting of columns is not limited to the above-described example.

The processes in steps S23 and S24 are not necessarily carried out in this order, and may be carried out in the reverse order or in parallel. The processes in steps S23 and S24 do not necessarily need to be carried out. In other words, the matrix only needs to be sorted based at least on labels.

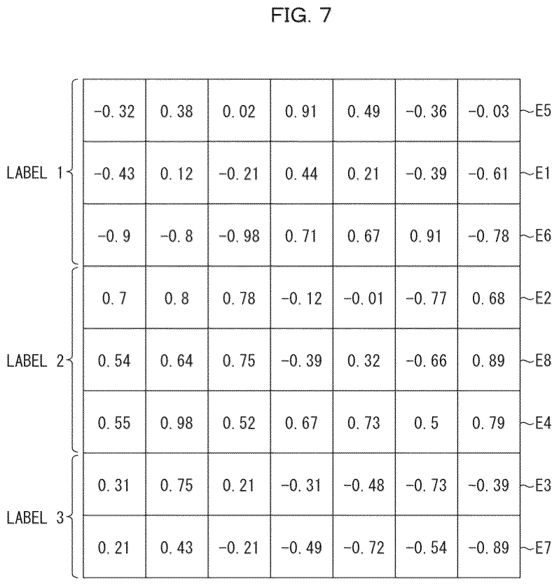

FIG. 7 is a schematic diagram illustrating an example of a matrix sorted based on labels. As illustrated in FIG. 7, a matrix A is a matrix of 8 rows and 7 columns which includes rows corresponding to the embeddings E1 through E8 illustrated in FIG. 5, respectively. Note here that the embeddings E1 through E8 are assumed to be 7-dimensional, and therefore the number of columns is seven. The plurality of rows are sorted based on labels “Label 1”, “Label 2”, and “Label 3” associated with embeddings corresponding to the respective rows. In this example, sorting based on first representative values for a plurality of rows and sorting based on second representative values for a plurality of columns have not been carried out.

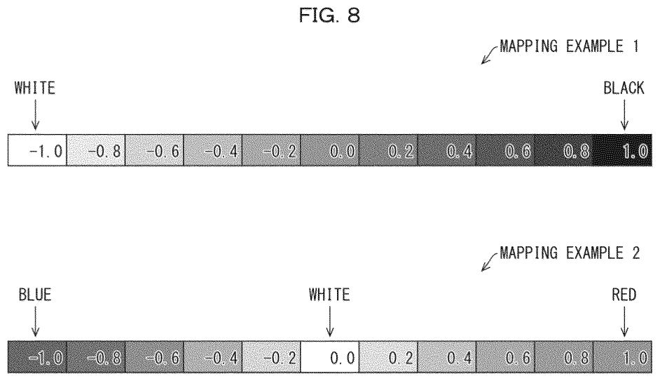

In step S25 illustrated in FIG. 6, the generation section 12A assigns pixel values, which represent a plurality of colors with a predetermined number of gradations, to values ranging from a minimum value to a maximum value of the elements of the matrix. For example, the plurality of colors may be two colors or three or more colors. Note that a minimum value and a maximum value which can be taken by each of elements of embeddings acquired from the embedding layer L1 are determined according to the pre-trained model M1. FIG. 8 is a schematic diagram illustrating a specific example of assignment of pixel values. In FIG. 8, it is assumed that a minimum value of element of the matrix is “−1” and a maximum value is “1”.

A mapping example 1 shows an example in which white is assigned to the minimum value “−1”, black is assigned to the maximum value “1”, and pixel values (so-called gray scale pixel values) which represent white to black with a predetermined number of gradations are assigned to numerical values from −1 to 1. In the mapping example 1, an example is shown in which white to black is represented by 11 gradations. Note, however, that the number of gradations is not limited to this example. For example, the number of gradations from white to black may be 256 gradations.

A mapping example 2 shows an example in which blue is assigned to the minimum value “−1”, white is assigned to an intermediate value “0”, and red is assigned to the maximum value “1”. In this example, pixel values which represent blue to white with a predetermined number of gradations are assigned to numerical values from −1 to 0, and pixel values which represent white to red with a predetermined number of gradations are assigned to numerical values from 0 to 1. In the mapping example 2, an example is shown in which blue to white is represented by six gradations and white to red is represented by six gradations to represent the entire range by 11 gradations. Note, however, that the number of gradations is not limited to this example. For example, in a case where blue to white is set to 256 gradations and white to red is set to 256 gradations, pixel values of 512 gradations are assigned to values ranging from the minimum value “−1” to the maximum value “1”.

Colors used for assignment of pixel values are not limited to two colors or three colors as illustrated in FIG. 8, and may be four or more colors. Types of colors used for assignment is not limited to the above-described example.

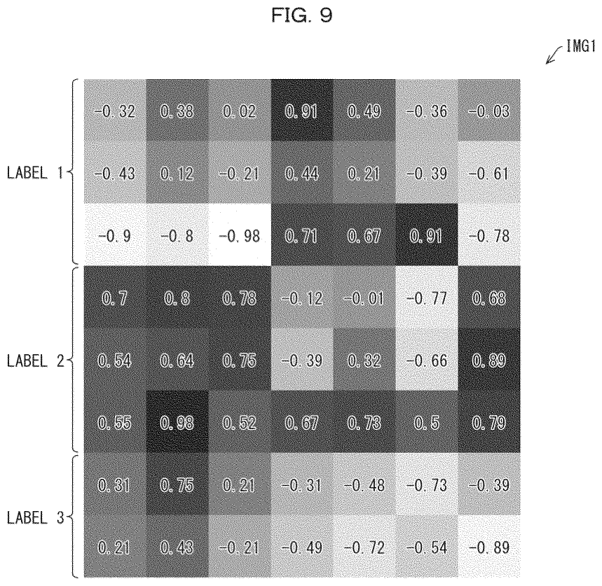

In step S26 illustrated in FIG. 6, the generation section 12A converts elements of the matrix into pixel values in accordance with assignment of the pixel values calculated in step S25. Thus, image data is generated. FIG. 9 is a schematic diagram illustrating an example of image data generated from a matrix in which embeddings are included in respective rows. In FIG. 9, image data IMG1 is gray scale image data generated by carrying out a conversion process according to the mapping example 1 illustrated in FIG. 8 with respect to elements included in the matrix A illustrated in FIG. 7. The image data IMG1 has eight vertical pixels which correspond to the number of training data pieces (=8) and has seven horizontal pixels which correspond to the number of dimensions of embedding (=7). In FIG. 9, numerical values included in cells indicating the respective pixels show, for clarity, elements of the matrix A corresponding to the pixels. That is, the numerical values do not indicate that figures having numerical shapes are included in the image data IMG1.

The image data thus generated has the number of vertical pixels which corresponds to the number of training data pieces and has the number of horizontal pixels which corresponds to the number of dimensions of embedding. The generation section 12A may carry out the processes in and subsequent to step S13A by using image data which has been obtained by enlarging the generated image data. For example, in the example of FIG. 9, it is possible to use image data of 16×14 which has been obtained by vertically and horizontally enlarging, by a factor of 2, image data having vertical pixels and horizontal pixels of 8×7. Thus, there is a possibility that a process of detecting a first boundary is facilitated as compared with a case where the enlargement is not carried out. In a case where image data is enlarged, it is not necessary to maintain an aspect ratio. For example, in a case where the number of vertical pixels is smaller (or larger) than the number of horizontal pixels, a vertical enlargement ratio may be larger (or smaller) than a horizontal enlargement ratio. A magnification in a case of enlarging image data is not limited to the above-described example. This is the end of the detailed description of step S12A illustrated in FIG. 6.

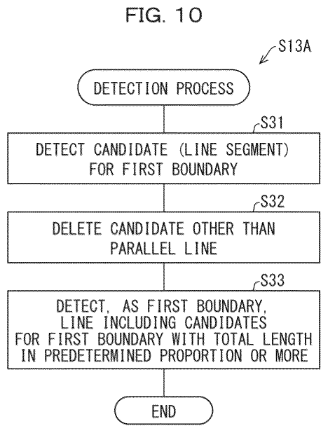

In step S13A illustrated in FIG. 6, the detection section 13A detects, as a feature of the image data, a first boundary based on change in pixel value. FIG. 10 is a flowchart illustrating a detailed flow of a detection process in step S13A. As illustrated in FIG. 10, the detection process (step S13A) includes steps S31 through S33.

In step S31, the detection section 13A detects, in the image data, a candidate for first boundary based on change in pixel value. Here, a first boundary to be detected is a boundary which conforms to a linear second boundary (described later). Therefore, the first boundary to be detected is a linear boundary. For example, a known technique of detecting a straight line based on change in pixel value from image data can be employed in the process of detecting a candidate for first boundary. Examples of the known technique include, but are not limited to, line segment detector (LSD), Hough transform, and the like. The detection section 13A detects one or more line segments as candidates for first boundary.

In step S32, among the detected one or more candidates for first boundary, the detection section 13A deletes a candidate(s) which has been determined not to be parallel to the row direction of the image data (i.e., a line segment(s) other than a parallel line). For example, the detection section 13A may determine that a candidate which forms an angle larger than 0 with the row direction is not parallel to the row direction and delete such a candidate, where an inclination up to the angle θ with respect to the row direction is set to be a permissible range. Thus, the one or more candidates for first boundary are all parallel to the row direction. This is because the first boundary to be detected is a boundary which conforms to a second boundary (described later) which is parallel to the direction of row corresponding to an embedding.

In step S33, in a case where one or more candidates for first boundary are included in a parallel line parallel to one side of image data, and a total length of the one or more candidates for first boundary is equal to or more than a predetermined proportion of a length of the one side, the detection section 13A detects the parallel line as a first boundary. For example, it is possible to apply, as the predetermined proportion, 10% or the like of the number of pixels (corresponding to the number of dimensions of an embedding in a case where the image data is not enlarged) of one side in the row direction of the image data. For example, in a case where the number of dimensions of an embedding is 700 and a total length of candidates for first boundary included in a parallel line is 70 pixels or more, the parallel line is detected as a first boundary.

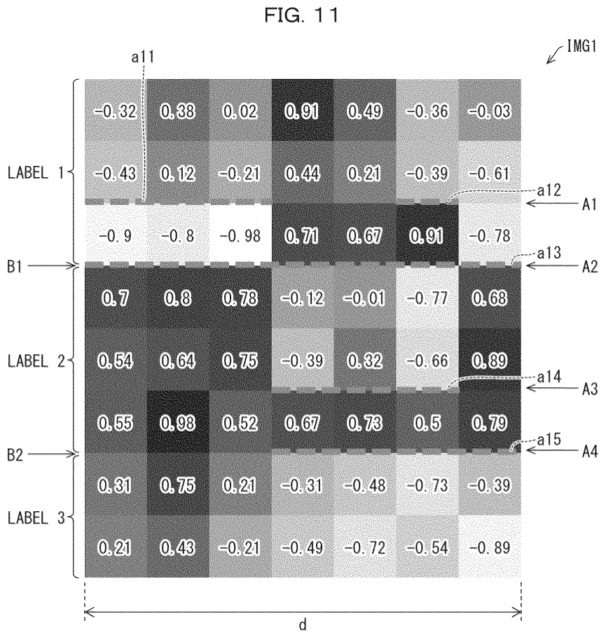

FIG. 11 is a schematic diagram illustrating an example of first boundaries detected in the image data. In FIG. 11, candidates a11 and a12 for first boundary are included in a parallel line A1 parallel to the row direction of the image data IMG1. A total length of the candidates a11 and a12 is equal to or more than a predetermined proportion (e.g., 10%) of a length d of one side parallel to the row direction of the image data IMG1. Therefore, the detection section 13A detects the parallel line A1 as a first boundary A1. In FIG. 11, a candidate a13 for first boundary is included in a parallel line A2, and a length of the candidate a13 is equal to or more than the predetermined proportion of the length d of one side. Therefore, the parallel line A2 is detected as a first boundary A2. Similarly, a parallel line A3 including a candidate a14 is detected as a first boundary A3, and a parallel line A4 including a candidate a15 is detected as a first boundary A4.

In step S31, the detection section 13A may detect, as a candidate for first boundary, a line segment having a length equal to or more than a predetermined proportion of the length of one side parallel to the row direction. In this case, the process of step S33 can be omitted. This is the end of the detailed description of step S13A illustrated in FIG. 6.

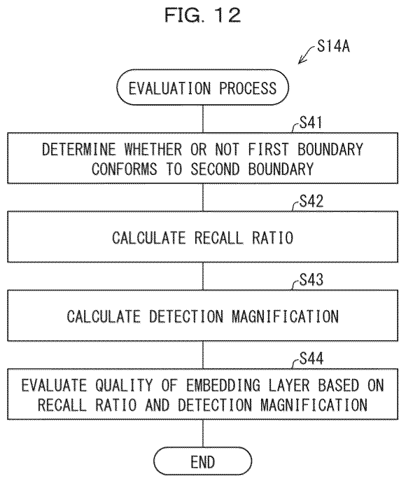

In step S14A illustrated in FIG. 6, the evaluation section 14A evaluates quality of an embedding layer based on a result of comparison between the first boundary and the second boundary. FIG. 12 is a flowchart illustrating a detailed flow of the evaluation process in step S14A. As illustrated in FIG. 12, the evaluation process (step S14A) includes steps S41 through S44.

In step S41, the evaluation section 14A determines whether each of the one or more first boundaries detected in step S13A conforms to any of one or more second boundaries. Here, an example will be described in which image data is generated from a matrix including embeddings as rows. Therefore, the second boundary indicates a border between rows corresponding to embeddings associated with different labels in the image data. The following description will discuss a specific example of the process in step S41, with reference to FIG. 11.

In the image data IMG1 illustrated in FIG. 11, rows 1 through 3 correspond to embeddings associated with a label 1. Rows 4 through 6 correspond to embeddings associated with a label 2. Rows 7 and 8 correspond to embeddings associated with a label 3. Therefore, a line indicating a border between the row 3 corresponding to the label 1 and the row 4 corresponding to the label 2 is a second boundary B1. A line indicating a border between the row 6 corresponding to the label 2 and the row 7 corresponding to the label 3 is a second boundary B2. The evaluation section 14A determines that there is no second boundary which conforms to the first boundary A1. The evaluation section 14A determines that the first boundary A2 conforms to the second boundary B1. The evaluation section 14A determines that there is no second boundary conforming to the first boundary A3. The evaluation section 14A determines that the first boundary A4 conforms to the second boundary B2.

In step S42, the evaluation section 14A calculates a recall ratio. Here, the recall ratio indicates a proportion of the number of first boundaries which have been determined to conform to second boundaries to the number of second boundaries. In the example of FIG. 11, the number of first boundaries which have been determined to conform to second boundaries is two, i.e., first boundaries A2 and A4, and the number of second boundaries is two, i.e., the second boundaries B1 and B2. Therefore, the recall ratio is calculated to be 1.

In step S43, the evaluation section 14A calculates a detection magnification. Here, the detection magnification is a proportion of the number of first boundaries to the number of second boundaries. In the example of FIG. 11, the number of first boundaries is four, i.e., the first boundaries A1 through A4, and the number of second boundaries is two, i.e., the second boundaries B1 and B2. Therefore, the detection magnification is calculated to be 2.

In step S44, the evaluation section 14A evaluates quality of the embedding layer based on a determination criterion with reference to the recall ratio and the detection magnification. For example, the determination criterion may be a criterion that both conditions in which the recall ratio is equal to or greater than a first threshold value and the detection magnification is equal to or less than a second threshold value are satisfied. In this case, an evaluation result may be one that t indicates whether the quality is satisfactory or not in accordance with whether or not the determination criterion is satisfied. In a case where 1 is applied as the first threshold value and 50 is applied as the second threshold value, in the example of FIG. 11, both the recall ratio 1 and the detection magnification 2 satisfy the determination criterion, and therefore the quality is determined to be good. The determination criterion is not limited to the example described above. The evaluation result is not limited to a binary value indicating good or not, and may be expressed by three or more levels (e.g., good, normal, poor, and the like), or a score or the like that indicates a degree of quality. This is the end of the detailed description of step S14A illustrated in FIG. 6.

In step S15A illustrated in FIG. 6, the output section 15A outputs, to the display apparatus 3, one or both of the evaluation result by the evaluation section 14A and the image data generated by the generation section 12A. For example, the evaluation result to be output may include information that indicates whether quality of the embedding layer is satisfactory or not. An example of information indicating that the quality of the embedding layer is satisfactory is character information stating that “The embedding layer of this language processing model has been determined to be appropriate”. An example of information indicating that the quality of the embedding layer is not satisfactory is character information stating that “The embedding layer of this language processing model has been determined to be inappropriate. Please check the training data set and consider changing the pre-trained model”, or the like. The evaluation result to be output may include information indicating the recall ratio and the detection magnification. The evaluation result to be output may include information indicating the determination criterion used for determining whether the quality of the embedding layer is satisfactory or not.

Lines indicating a first boundary and a second boundary may be superimposed on the image data to be output. The first boundary superimposed on the image data to be output may be in a distinguishable display mode in which it is possible to see whether or not the first boundary conforms to the second boundary. The second boundary superimposed on the image data to be output may be in a distinguishable display mode in which it is possible to see whether or not the second boundary conforms to the first boundary. The distinguishable display mode may be, for example, a mode in which colors, thicknesses, types of lines, and the like are made different. This is the end of the description of the evaluation method S1A.

### (Variation of Evaluation Method S1A)

The evaluation method S1A can be modified as follows. In a case where the evaluation apparatus 1A has determined that an evaluation result (hereinafter referred to as a first evaluation result) of quality of the embedding layer obtained by carrying out steps S11A through S14A for the first time does not satisfy the determination criterion, the evaluation apparatus 1A may carry out steps S11A through S14A for the second time. In steps S11A through S14A for the second time, the training data set DS1 identical to that for the first time and a language processing model M2-1 different from that for the first time are used. As described above, the language processing model M2-1 can be a model generated using the same training data set DS1 based on a pre-trained model M1-1 different from the pre-trained model M1. By carrying out steps S11A through S14A for the second time, an evaluation result (hereinafter referred to as a second evaluation result) of the quality of the embedding layer is obtained.

In this variation, after step S14A for the second is carried out, the evaluation section 14A determines whether or not the second evaluation result satisfies the determination criterion. In a case where the second evaluation result does not satisfy the determination criterion as with the first evaluation result, the evaluation section 14A evaluates that the quality of the training data set DS1 does not satisfy the criterion. That is, a cause of a case where performance of the language processing models M2 and M2-1 is not satisfactory is narrowed down to the training data set DS1.

The evaluation section 14A may carry out steps S11A through S14A not only twice but also a plurality of times (e.g., for the second time, third time, and so forth) in a case where the first evaluation result does not satisfy the determination criterion. For example, in a case where the first evaluation result does not satisfy the determination criterion, the evaluation section 14A may obtain two or more evaluation results (second evaluation result, third evaluation result, and the like) by using the same training data set DS1 and two or more different language processing models (M2-1, M2-2, and the like). For example, the plurality of language processing models (M2, M2-1, M2-2, and the like) may be obtained by fine-tuning a plurality of different pre-trained models (M1, M1-1, M1-2, and the like) using the same training data set DS1. In this case, the evaluation section 14A may evaluate quality of the training data set DS1 based on a statistical value of three or more evaluation results (first evaluation result, second evaluation result, third evaluation result, and the like). For example, in a case where a predetermined proportion or more of the three or more evaluation results does not satisfy the criterion, the evaluation section 14A may evaluate that the quality of the training data set DS1 does not satisfy the criterion.

In this case, in step S15A, the output section 15A may output information indicating that the quality of the training data set DS1 does not satisfy the criterion. Examples of such information include character information stating that “None of the embedding layers of the plurality of language processing models generated using the same training data set has been determined to be appropriate. Please confirm that there is a probable cause in the training data set”, or the like.

In a case where the first evaluation result satisfies the determination criterion, the evaluation apparatus 1A may carry out step S15A in a manner similar to that described above, without carrying out steps S11A through S14A for the second and subsequent times. The evaluation apparatus 1A may carry out steps S11A through S14A for the second and subsequent times, regardless of the first evaluation result.

### Specific Example

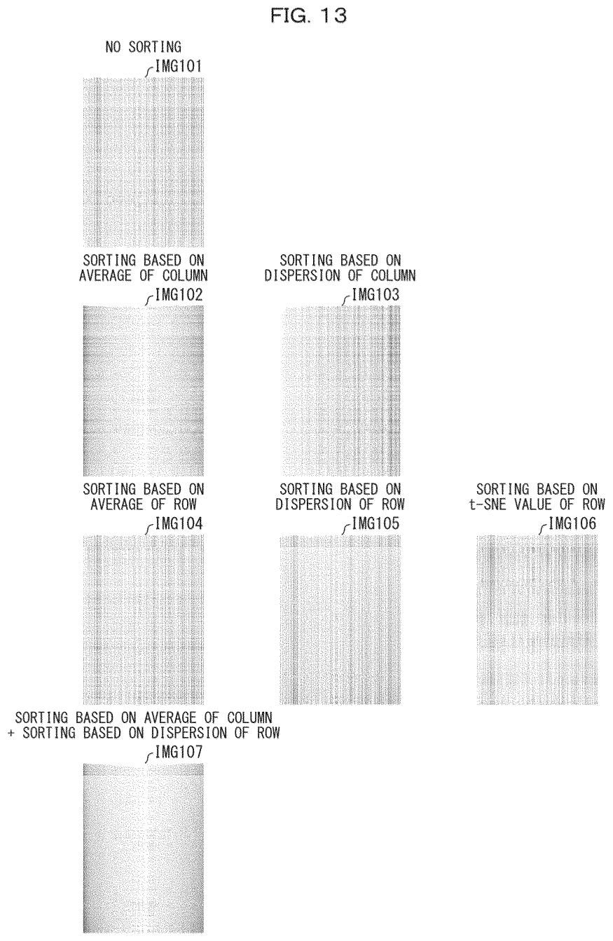

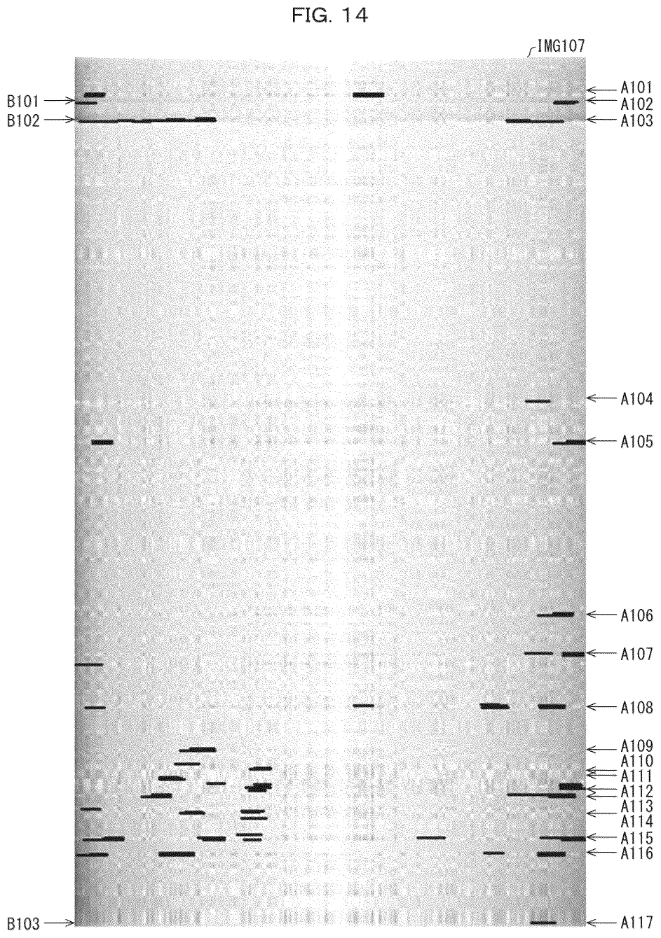

Here, a specific example will be described in which the evaluation method S1A is carried out, with reference to FIGS. 13 and 14. In this specific example, a subject is a language processing model M2 which has been generated using Japanese BERT as a pre-trained model M1 and using a training data set DS constituted by 2749 training data pieces. In this example, embeddings output by the pre-trained model M1 are 768-dimensional. Therefore, embeddings acquired from the embedding layer L1 are also 768-dimensional.

FIG. 13 is a diagram illustrating image data generated in step S12A in this specific example. In FIG. 13, pieces of image data IMG101 through IMG107 are generated from a matrix which includes, as rows, 768-dimensional embeddings which have been respectively acquired from 2749 training data pieces. Therefore, the number of vertical and horizontal pixels is 2749×768. The pieces of image data IMG101 through IMG107 are generated by carrying out, on the matrix, the conversion process in the mapping example 2 illustrated in FIG. 8, and therefore are each image data of three-color scale.

Here, the image data IMG101 is image data generated from a matrix in which sorting of rows has been carried out based on labels. In the image data IMG101, sorting of rows and columns other than the sorting of rows based on labels is not carried out.

The pieces of image data IMG102 and IMG103 are each generated from a matrix in which sorting of columns is carried out in addition to sorting of rows based on labels. In the image data IMG102, the sorting of columns is carried out based on an average (an example of a second representative value) of each column. In the image data IMG103, the sorting of columns is carried out based on a dispersion (an example of a second representative value) of each column.

The pieces of image data IMG104 through IMG106 are each generated from a matrix in which, in addition to sorting rows based on labels, a plurality of rows associated with the same label have been sorted. In the image data IMG104, sorting of a plurality of rows associated with the same label is carried out based on an average (an example of a first representative value) of each row. In the image data IMG105, sorting of a plurality of rows associated with the same label is carried out based on a dispersion (an example of a first representative value) of each row.

In the image data IMG106, sorting of a plurality of rows associated with the same label is carried out based on a value (an example of a first representative value) obtained from each row by t-distributed stochastic neighbor embedding (t-SNE). Hereinafter, the value obtained by t-SNE is also referred to as a t-SNE value. In this example, as the t-SNE value, a value obtained by compressing a 768-dimensional row into one dimension by t-SNE is applied. Note, however, that, in a case where sorting is carried out using the t-SNE value, the number of dimensions after compression and an ordinal number of element therein used for sorting are not limited to the example described above.

Although not illustrated in FIG. 12, the sorting based on the t-SNE value may be applied to the columns, in addition to the rows. That is, image data may be generated from a matrix in which, in addition to sorting rows based on labels, sorting of columns has been carried out based on a value (an example of a second representative value) obtained from each of the columns by t-SNE.

The image data IMG107 is generated from a matrix (i) in which, in addition to sorting of rows based on labels, sorting of a plurality of rows associated with the same label has been carried out based on a dispersion (an example of a first representative value) of each row and (ii) in which sorting of columns has been carried out based on an average (an example of a second representative value) of each column.

Note that, in a case where both sorting of rows and sorting of columns are carried out in order to generate image data, a combination of the first representative value and the second representative value is not limited to the example described above. For example, although not illustrated in FIG. 12, image data may be generated from a matrix in which sorting of a plurality of rows associated with the same label is carried out based on one of the following three parameters: “average, dispersion, and t-SNE value”, and sorting of columns is carried out based on one of the following three parameters: “average, dispersion, and t-SNE value”.

FIG. 14 is a diagram illustrating first boundaries and second boundaries in this specific example. In FIG. 14, line segments shown inside the image data IMG107 indicate candidates for first boundary. Further, in this example, first boundaries A101 through A117 have been detected based on such candidates for first boundary. Second boundaries B101 through B103 on the image data IMG107 indicate borders between rows associated with different labels. Among the first boundaries A101 through A117, the first boundary A102 conforms to the second boundary B101. The first boundary A103 conforms to the second boundary B102. The first boundary A117 conforms to the second boundary B103. As the recall ratio, “1” is calculated as a proportion of the number of pieces “3” of conformed boundaries to the number of pieces “3” of the second boundaries. As the detection magnification, approximately “5.7” is calculated as a proportion of the number of pieces “17” of the first boundaries to the number of pieces “3” of the second boundaries. In a case where “the recall ratio of 1 or more and the detection magnification of 50 or less” are applied as the determination criterion, the quality of the embedding layer L1 is evaluated to be good.

### Application Example

The evaluation apparatus 1A in accordance with the present example embodiment can be applied, for example, in the field of health care or medical care. For example, by using the evaluation apparatus 1A for a language processing model which has been subjected to machine learning so as to classify electronic medical records which are recorded by doctors for patients, the evaluation apparatus 1A can be used for an application of narrowing down a cause in a case where performance of the language processing model is poor.

### (Example Advantage of Present Example Embodiment)

As described above, the evaluation apparatus 1A in accordance with the present example embodiment employs, in addition to the configuration similar to the first example embodiment, the configuration in which: the language processing model is a model that carries out a classification task; the plurality of training data pieces include respective pieces of information in which the natural language sentences are associated with respective labels indicating classifications of the respective natural language sentences; the generation section 12A generates image data from a matrix in which the embeddings are arranged, as rows or columns, in an order based on the labels; the detection section 13A detects, as a feature of the image data, a first boundary based on change in pixel value; and the evaluation section 14A evaluates the quality of the embedding layer based on a result of comparison between the first boundary and a second boundary which indicates a border between rows or columns corresponding to embeddings associated with different labels in the image data.

Therefore, according to the present example embodiment, it can be seen that, in a case where performance of a language processing model for carrying out a classification task is not satisfactory and quality of an embedding layer included in the language processing model is not satisfactory, it is highly likely that a cause of such a case is a training data set, a pre-trained model, or a training algorithm. In a case where quality of an embedding layer is satisfactory, it is considered that quality of a classification layer is not satisfactory, and it can be seen that hyperparameters are highly likely to be a cause of such a case. As a result, it is possible to narrow down a cause of a case where performance of a language processing model which carries out a classification task is not satisfactory.

The evaluation apparatus 1A in accordance with the present example embodiment employs the configuration in which: the evaluation section 14A evaluates the quality of the embedding layer based on a recall ratio that indicates a proportion of the number of first boundaries which have been determined to conform to second boundaries to the number of second boundaries. Therefore, according to the present example embodiment, it is possible to bring about an example advantage of evaluating quality of the embedding layer with higher accuracy, in addition to the foregoing example advantages.

The evaluation apparatus 1A in accordance with the present example embodiment employs the configuration in which: the evaluation section 14A evaluates the quality of the embedding layer based on a detection magnification that indicates a proportion of the number of first boundaries to the number of second boundaries. Therefore, according to the present example embodiment, it is possible to bring about an example advantage of evaluating quality of the embedding layer with higher accuracy, in addition to the foregoing example advantages.

The evaluation apparatus 1A in accordance with the present example embodiment employs the configuration in which: the generation section 12A generates image data from a sorted matrix in which a plurality of rows included in the matrix have been sorted based on a first representative value calculated from elements in each of the plurality of rows. Therefore, according to the present example embodiment, it is possible to bring about an example advantage of detecting, with higher accuracy, a first boundary which conforms to a second boundary, in addition to the foregoing example advantages.

The evaluation apparatus 1A in accordance with the present example embodiment employs the configuration in which: the generation section 12A generates image data from a sorted matrix in which a plurality of columns included in the matrix have been sorted based on a second representative value calculated from elements in each of the plurality of columns. Therefore, according to the present example embodiment, it is possible to bring about an example advantage of detecting, with higher accuracy, a first boundary which conforms to a second boundary, in addition to the foregoing example advantages.

In the evaluation apparatus 1A in accordance with the present example embodiment, a result of evaluating the quality of the embedding layer obtained by causing the acquisition section 11A, the generation section 12A, the detection section 13A, and the evaluation section 14A to function while applying the language processing model M2 as a language processing model is used as a first evaluation result. Moreover, a result of evaluating the quality of the embedding layer obtained by causing the acquisition section 11A, the generation section 12A, the detection section 13A, and the evaluation section 14A to function while applying the language processing model M2-1, which is different from the language processing model M2, as a language processing model is used as a second evaluation result. The following configuration is employed in which, in a case where the same training data set DS1 is used to obtain both a first evaluation result and a second evaluation result, and neither the first evaluation result nor the second evaluation result satisfies a criterion, the evaluation section 14A evaluates that quality of the training data set DS1 does not satisfy a criterion. Therefore, according to the present example embodiment, it is possible to bring about an example advantage of narrowing down a cause of a case where performance of a language processing model is not satisfactory to a training data set.

The evaluation apparatus 1A in accordance with the present example embodiment employs the configuration in which: the generation section 12A converts elements of the matrix into pixel values by assigning pixel values, which represent a plurality of colors with a predetermined number of gradations, to values ranging from a minimum value to a maximum value of the elements of the matrix. Therefore, according to the present example embodiment, it is possible to bring about an example advantage of detecting, with higher accuracy, a first boundary which conforms to a second boundary, in addition to the foregoing example advantages.

The evaluation apparatus 1A in accordance with the present example embodiment employs the configuration of further including the output section 15A for outputting one or both of an evaluation result by the evaluation section 14A and image data generated by the generation section 12A. Therefore, according to the present example embodiment, it is possible to bring about an example advantage of recognizing, by a user, a result of evaluating quality of an embedding layer, in addition to the foregoing example advantages.

The evaluation apparatus 1A in accordance with the present example embodiment employs the configuration in which: among candidates for first boundary detected based on change in pixel value, the detection section 13A detects, as the first boundary, a candidate extending parallel to a direction of row or column corresponding to an embedding in the image data. Therefore, according to the present example embodiment, it is possible to bring about an example advantage of reducing detection of a first boundary which does not conform to a second boundary, in addition to the foregoing example advantages.

The evaluation apparatus 1A in accordance with the present example embodiment employs the configuration in which: in a case where a total length of one or more parallel candidates included in a parallel line parallel to one side of the image data is equal to or more than a predetermined proportion with respect to a length of the one side, the detection section 13A detects the parallel line as a first boundary. Therefore, according to the present example embodiment, it is possible to bring about an example advantage of reducing detection of a first boundary which does not conform to a second boundary, in addition to the foregoing example advantages.

### [Variation]

In the foregoing second example embodiment, an example has been described in which a language processing model is a model that carries out a classification task. Note, however, that the language processing model may be a model that carries out a language processing task other than the classification task.

In the foregoing second example embodiment, the evaluation apparatus 1A has been described as being included in the evaluation system 10. However, the evaluation apparatus 1A does not necessarily need to be included in the evaluation system 10. For example, the evaluation apparatus 1A does not need to be able to access the training data set DS1 itself and the embedding layer L1 itself, provided that the evaluation apparatus 1A is accessible to the storage apparatus in which embeddings are stored which have been generated using the embedding layer L1 for respective training data pieces included in the training data set DS1.

### [Software Implementation Example]

Some or all of the e functions of each of the evaluation apparatuses 1 and 1A (hereinafter referred to as a present apparatus) may be implemented by hardware such as an integrated circuit (IC chip), or may be implemented by software.

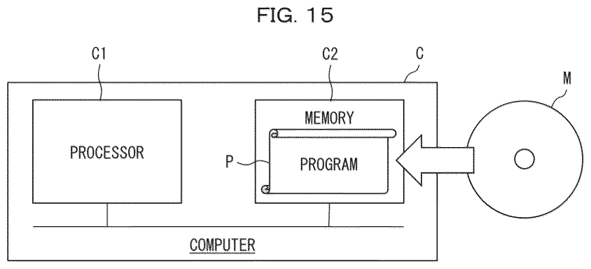

In the latter case, the present apparatus is realized by, for example, a computer that executes instructions of a program that is software realizing the foregoing functions. FIG. 15 illustrates an example of such a computer (hereinafter, referred to as “computer C”). The computer C includes at least one processor C1 and at least one memory C2. The memory C2 stores a program P for causing the computer C to function as the present apparatus. In the computer C, the processor C1 reads the program P from the memory C2 and executes the program P, so that the functions of the present apparatus are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

Some or all of the foregoing example embodiments can also be described as below. Note, however, that the present invention is not limited to the following supplementary notes.

### (Supplementary Note 1)

An evaluation apparatus, including: an acquisition means for acquiring embeddings for natural language sentences that are respectively included in a plurality of training data pieces, the embeddings having been generated with use of an embedding layer included in a language processing model; a generation means for generating image data by converting elements of a matrix which includes the embeddings as rows or columns into pixel values; a detection means for detecting a feature of the image data; and an evaluation means for evaluating quality of the embedding layer based on the feature of the image data.

### (Supplementary Note 2)

The evaluation apparatus according to supplementary note 1, in which: the language processing model is a model that carries out a classification task; the plurality of training data pieces include respective pieces of information in which the natural language sentences are associated with respective labels indicating classifications of the respective natural language sentences; the generation means generates image data from a matrix in which the embeddings are arranged, as rows or columns, in an order based on the labels; the detection means detects, as a feature of the image data, a first boundary based on change in pixel value; and the evaluation means evaluates the quality of the embedding layer based on a result of comparison between the first boundary and a second boundary which indicates a border between rows or columns corresponding to embeddings associated with different labels in the image data.

### (Supplementary Note 3)

The evaluation apparatus according to supplementary note 2, in which: the evaluation means evaluates the quality of the embedding layer based on a recall ratio that indicates a proportion of the number of first boundaries which have been determined to conform to second boundaries to the number of second boundaries.

### (Supplementary Note 4)

The evaluation apparatus according to supplementary note 2 or 3, in which: the evaluation means evaluates the quality of the embedding layer based on a detection magnification that indicates a proportion of the number of first boundaries to the number of second boundaries.

### (Supplementary Note 5)

The evaluation apparatus according to any one of supplementary notes 1 through 4, in which: the generation means generates image data from a sorted matrix in which a plurality of rows included in the matrix have been sorted based on a first representative value calculated from elements in each of the plurality of rows.

### (Supplementary Note 6)

The evaluation apparatus according to any one of supplementary notes 1 through 5, in which: the generation means generates image data from a sorted matrix in which a plurality of columns included in the matrix have been sorted based on a second representative value calculated from elements in each of the plurality of columns.

### (Supplementary Note 7)

The evaluation apparatus according to any one of supplementary notes 1 through 6, in which: the acquisition means, the generation means, the detection means, and the evaluation means are functioned while applying a first language processing model as the language processing model, and thus a result of evaluating the quality of the embedding layer is obtained as a first evaluation result; the acquisition means, the generation means, the detection means, and the evaluation means are functioned while applying a second language processing model as the language processing model, and thus a result of evaluating the quality of the embedding layer is obtained as a second evaluation result, the second language processing model being different from the first language processing model; and in a case where a plurality of training data pieces are used to obtain both the first evaluation result and the second evaluation result, and neither the first evaluation result nor the second evaluation result satisfies a predetermined criterion, the evaluation means evaluates that quality of the plurality of training data pieces does not satisfy a criterion.

### (Supplementary Note 8)

The evaluation apparatus according to any one of supplementary notes 1 through 7, in which: the generation means converts elements of the matrix into pixel values by assigning pixel values, which represent a plurality of colors with a predetermined number of gradations, to values ranging from a minimum value to a maximum value of the elements of the matrix.

### (Supplementary Note 9)

The evaluation apparatus according to any one of supplementary notes 1 through 8, further including: an output means for outputting one or both of an evaluation result by the evaluation means and image data generated by the generation means.

### (Supplementary Note 10)

The evaluation apparatus according to any one of supplementary notes 2 through 4, in which: among candidates for first boundary detected based on change in pixel value, the detection means detects, as the first boundary, a candidate extending parallel to a direction of row or column corresponding to an embedding in the image data.

### (Supplementary Note 11)

The evaluation apparatus according to supplementary note 10, in which: in a case where a total length of one or more parallel candidates included in a parallel line parallel to one side of the image data is equal to or more than a predetermined proportion with respect to a length of the one side, the detection means detects the parallel line as a first boundary.

### (Supplementary Note 12)

An evaluation method carried out by at least one processor, the evaluation method including: acquiring, by the at least one processor, embeddings for natural language sentences that are respectively included in a plurality of training data pieces, the embeddings having been generated with use of an embedding layer included in a language processing model; generating, by the at least one processor, image data by converting elements of a matrix which includes the embeddings as rows or columns into pixel values; detecting, by the at least one processor, a feature of the image data; and evaluating, by the at least one processor, quality of the embedding layer based on the feature of the image data.

### (Supplementary Note 13)

A program for causing a computer to function as: an acquisition means for acquiring embeddings for natural language sentences that are respectively included in a plurality of training data pieces, the embeddings having been generated with use of an embedding layer included in a language processing model; a generation means for generating image data by converting elements of a matrix which includes the embeddings as rows or columns into pixel values; a detection means for detecting a feature of the image data; and an evaluation means for evaluating quality of the embedding layer based on the feature of the image data.

### [Additional Remark 3]

Furthermore, some of or all of the foregoing example embodiments can also be expressed as below.

### (Supplementary Note 1)

An evaluation apparatus, including at least one processor, the at least one processor carrying out: an acquisition process of acquiring embeddings for natural language sentences that are respectively included in a plurality of training data pieces, the embeddings having been generated with use of an embedding layer included in a language processing model; a generation process of generating image data by converting elements of a matrix which includes the embeddings as rows or columns into pixel values; a detection process of detecting a feature of the image data; and an evaluation process of evaluating quality of the embedding layer based on the feature of the image data.

### (Supplementary Note 2)

The evaluation apparatus according to supplementary note 1, in which: the language processing model is a model that carries out a classification task; the plurality of training data pieces include respective pieces of information in which the natural language sentences are associated with respective labels indicating classifications of the respective natural language sentences; in the generation process, the at least one processor generates image data from a matrix in which the embeddings are arranged, as rows or columns, in an order based on the labels; in the detection process, the at least one processor detects, as a feature of the image data, a first boundary based on change in pixel value; and in the evaluation process, the at least one processor evaluates the quality of the embedding layer based on a result of comparison between the first boundary and a second boundary which indicates a border between rows or columns corresponding to embeddings associated with different labels in the image data.

### (Supplementary Note 3)

The evaluation apparatus according to supplementary note 2, in which: in the evaluation process, the at least one processor evaluates the quality of the embedding layer based on a recall ratio that indicates a proportion of the number of first boundaries which have been determined to conform to second boundaries to the number of second boundaries.

### (Supplementary Note 4)

The evaluation apparatus according to supplementary note 2 or 3, in which: in the evaluation process, the at least one processor evaluates the quality of the embedding layer based on a detection magnification that indicates a proportion of the number of first boundaries to the number of second boundaries.

### (Supplementary Note 5)

The evaluation apparatus according to any one of supplementary notes 1 through 4, in which: in the generation process, the at least one processor generates image data from a sorted matrix in which a plurality of rows included in the matrix have been sorted based on a first representative value calculated from elements in each of the plurality of rows.

### (Supplementary Note 6)

The evaluation apparatus according to any one of supplementary notes 1 through 5, in which: in the generation process, the at least one processor generates image data from a sorted matrix in which a plurality of columns included in the matrix have been sorted based on a second representative value calculated from elements in each of the plurality of columns.

### (Supplementary Note 7)

The evaluation apparatus according to any one of supplementary notes 1 through 6, in which: the acquisition process, the generation process, the detection process, and the evaluation process are carried out while applying a first language processing model as the language processing model, and thus a result of evaluating the quality of the embedding layer is obtained as a first evaluation result; the acquisition process, the generation process, the detection process, and the evaluation process are carried out while applying a second language processing model as the language processing model, and thus a result of evaluating the quality of the embedding layer is obtained as a second evaluation result, the second language processing model being different from the first language processing model; and in the evaluation process, in a case where a plurality of training data pieces are used to obtain both the first evaluation result and the second evaluation result, and neither the first evaluation result nor the second evaluation result satisfies a predetermined criterion, the at least one processor evaluates that quality of the plurality of training data pieces does not satisfy a criterion.

### (Supplementary Note 8)

The evaluation apparatus according to any one of supplementary notes 1 through 7, in which: in the generation process, the at least one processor converts elements of the matrix into pixel values by assigning pixel values, which represent a plurality of colors with a predetermined number of gradations, to values ranging from a minimum value to a maximum value of the elements of the matrix.

### (Supplementary Note 9)

The evaluation apparatus according to any one of supplementary notes 1 through 8, in which: the at least one processor further carries out an output process of outputting one or both of an evaluation result obtained in the evaluation process and image data generated in the generation process.

### (Supplementary Note 10)

The evaluation apparatus according to any one of supplementary notes 2 through 4, in which: in the detection process, among candidates for first boundary detected based on change in pixel value, the at least one processor detects, as the first boundary, a candidate extending parallel to a direction of row or column corresponding to an embedding in the image data.

### (Supplementary Note 11)

The evaluation apparatus according to supplementary note 10, in which: in the detection process, in a case where a total length of one or more parallel candidates included in a parallel line parallel to one side of the image data is equal to or more than a predetermined proportion with respect to a length of the one side, the at least one processor detects the parallel line as a first boundary.

Note that the evaluation apparatus according to any one of supplementary notes 1 through 11 in Additional remark 3 can further include a memory. The memory can store a program for causing the at least one processor to carry out the acquisition process, the generation process, the detection process, and the evaluation process. The program can be stored in a computer-readable non-transitory tangible storage medium.

### REFERENCE SIGNS LIST

1, 1A: Evaluation apparatus
2: Training apparatus
3: Display apparatus
10: Evaluation system
11, 11A: Acquisition section
12, 12A: Generation section
13, 13A: Detection section
14, 14A: Evaluation section
15A: Output section
C1: Processor
C2: Memory

1. An evaluation apparatus, comprising at least one processor, the at least one processor carrying out:
an acquisition process of acquiring embeddings for natural language sentences that are respectively included in a plurality of training data pieces, the embeddings having been generated with use of an embedding layer included in a language processing model;
a generation process of generating image data by converting elements of a matrix which includes the embeddings as rows or columns into pixel values;
a detection process of detecting a feature of the image data; and
an evaluation process of evaluating quality of the embedding layer based on the feature of the image data.

2. The evaluation apparatus according to claim 1, wherein:
the language processing model is a model that carries out a classification task;
the plurality of training data pieces include respective pieces of information in which the natural language sentences are associated with respective labels indicating classifications of the respective natural language sentences;
in the generation process, the at least one processor generates image data from a matrix in which the embeddings are arranged, as rows or columns, in an order based on the labels;
in the detection process, the at least one processor detects, as a feature of the image data, a first boundary based on change in pixel value; and
in the evaluation process, the at least one processor evaluates the quality of the embedding layer based on a result of comparison between the first boundary and a second boundary which indicates a border between rows or columns corresponding to embeddings associated with different labels in the image data.

3. The evaluation apparatus according to claim 2, wherein:
in the evaluation process, the at least one processor evaluates the quality of the embedding layer based on a recall ratio that indicates a proportion of the number of first boundaries which have been determined to conform to second boundaries to the number of second boundaries.

4. The evaluation apparatus according to claim 2, wherein:
in the evaluation process, the at least one processor evaluates the quality of the embedding layer based on a detection magnification that indicates a proportion of the number of first boundaries to the number of second boundaries.

5. The evaluation apparatus according to claim 1, wherein:
in the generation process, the at least one processor generates image data from a sorted matrix in which a plurality of rows included in the matrix have been sorted based on a first representative value calculated from elements in each of the plurality of rows.

6. The evaluation apparatus according to claim 1, wherein:
in the generation process, the at least one processor generates image data from a sorted matrix in which a plurality of columns included in the matrix have been sorted based on a second representative value calculated from elements in each of the plurality of columns.

7. The evaluation apparatus according to claim 1, wherein:
the at least one processor carries out the acquisition process, the generation process, the detection process, and the evaluation process while applying a first language processing model as the language processing model, and thus obtains, as a first evaluation result, a result of evaluating the quality of the embedding layer;
the at least one processor carries out the acquisition process, the generation process, the detection process, and the evaluation process while applying a second language processing model as the language processing model, and thus obtains, as a second evaluation result, a result of evaluating the quality of the embedding layer, the second language processing model being different from the first language processing model; and
in the evaluation process, in a case where a plurality of training data pieces are used to obtain both the first evaluation result and the second evaluation result, and neither the first evaluation result nor the second evaluation result satisfies a predetermined criterion, the at least one processor evaluates that quality of the plurality of training data pieces does not satisfy a criterion.

8. The evaluation apparatus according to claim 1, wherein:
the at least one processor further carries out an output process of outputting one or both of an evaluation result obtained in the evaluation process and image data generated in the generation process.

9. An evaluation method carried out by at least one processor, said evaluation method comprising:
acquiring, by the at least one processor, embeddings for natural language sentences that are respectively included in a plurality of training data pieces, the embeddings having been generated with use of an embedding layer included in a language processing model;
generating, by the at least one processor, image data by converting elements of a matrix which includes the embeddings as rows or columns into pixel values;
detecting, by the at least one processor, a feature of the image data; and
evaluating, by the at least one processor, quality of the embedding layer based on the feature of the image data.

10. A non-transitory storage medium storing a program for causing a computer to carry out:
an acquisition process of acquiring embeddings for natural language sentences that are respectively included in a plurality of training data pieces, the embeddings having been generated with use of an embedding layer included in a language processing model;
a generation process of generating image data by converting elements of a matrix which includes the embeddings as rows or columns into pixel values;
a detection process of detecting a feature of the image data; and
an evaluation process of evaluating quality of the embedding layer based on the feature of the image data.
